(19) United States
(12) Patent Application Publication
(10) Pub. No.: US 2011/0058306 A1
(43) Pub. Date: Mar. 10, 2011

(54) Chip-type electric double layer capacitor and package structure thereof

(75) Inventors: Sung Ho Lee, Seongnam-si (KR); Seung Hyun Ra, Seongnam-si (KR); Dong Sup Park, Suwon-si (KR); Yeong Su Cho, Guri-si (KR); Sang Kyun Lee, Suwon-si (KR); Hyun Chul Jung, Yongin-si (KR); Chang Ryul Jung, Seoul (KR)

(73) Assignee: SAMSUNG ELECTRO-MECHANICS CO., LTD., Suwon (KR)

(21) Appl. No.: 12/591,010

(22) Filed: Nov. 4, 2009

(30) Foreign Application Priority Data
Sep. 4, 2009 (KR) 10-2009-0083550

(51) Int. Cl. H01G 9/155; H01G 9/08

(52) U.S. Cl. 361/502

(57) ABSTRACT

Disclosed is a package structure of a chip-type electric double layer capacitor which includes a lower package, which houses an electric double layer element and has a package terminal formed thereon to be electrically connected to the electric double layer element, and an upper package which is disposed on a top part of the lower package and seals the electric double layer element from the outside, wherein the package terminals are formed to be protruded from an internal bottom surface and an external bottom surface of the lower package, and the external bottom surface of the lower package has at least two pairs of protrusions formed thereon.

### CROSS-REFERENCE TO RELATED APPLICATIONS

This application claims the benefit of Korean Patent Application No. 10-2009-0083550 filed with the Korea Intellectual Property Office on Sep. 4, 2009, the disclosure of which is incorporated herein by reference.

### BACKGROUND OF THE INVENTION

1. Field of the Invention

The present invention relates to a chip-type electric double layer capacitor which can employ a surface-mount technology and reduce leakage of electrolyte solution in a reflow process, and a package structure thereof.

2. Description of the Related Art

A rechargeable battery and an electric double layer capacitor (EDLC) are being widely used to supply a secondary power supply or a main power supply of mobile communication devices and portable electronic products including a notebook computer, etc. which have rapid charge and discharge characteristics of high-density energy.

Since the rechargeable battery has power density lower than the electric double layer capacitor, induces environmental pollution, has short charge/discharge cycles, overcharge, and a risk of exploding at high temperature, a high-performance electric double layer capacitor improving energy density has been recently developed.

The electric double layer capacitor means an electric condenser that accumulates electric energy by using an electrostatic environment generated in the electric double layer formed on an interface between a solid and an electrolyte.

Examples of application fields of the electric double layer capacitor include a system requiring an independent power supply device, a system adjusting instantaneously generated overload, an energy storage device, etc. Recently, a market is being expanded to the application fields.

In particular, a fact that the electric double layer capacitor is superior to the rechargeable battery in energy input/output (power density) is brought out, such that the applicability thereof is being extended as a back-up power supply which is the secondary power supply operating at the time of instantaneous power failure.

Further, since the electric double layer capacitor is superior to the rechargeable battery in charge/discharge efficiency or lifespan, has a relatively wide voltage range, needs not to be maintained, and has an environment-friendly advantage, the electric double layer capacitor is used as a energy source substituting for the rechargeable battery.

The electric double layer capacitor can be classified into a coin type, a cylinder type, and a square type in accordance with an explicit size.

The coin-type electric double layer capacitor has a structure activated carbon electrodes constituted by a pair of sheets are disposed with a separator interposed therebetween and is externally sealed by upper and lower metallic cases and a packing in the state where an electrolyte infiltrates the electrodes. The activated carbon electrodes of the coin-type electric double layer capacitor are in contact with the upper and lower metallic cases by a conductive adhesive. The capacity of the coin-type electric double layer capacitor is 2F or less and is used as a low-current load.

The square type electric double layer capacitor has an opposed structure in which the separator is interposed between a pair of electrodes acquired by applying an active material onto the surface of an aluminum (Al) collector. In the case of the square-type electric double layer capacitor, since a terminal draw-in/out method is simple, an electrode area is broad, and the thickness of the activated carbon electrode can be thinned, diffusion resistance is small and can be used in a larger capacity than the coin-type electric double layer capacitor. Therefore, the square-type electric double layer capacitor is suitable for a high-current load.

The cylinder-type electric double layer capacitor has a structure in which the pair of electrodes formed by applying the active material onto the surface of the aluminum (Al) collector are wound with the separator interposed therebetween and inserted into an aluminum case by being filtrated with the electrolyte, and thereafter, sealed with rubber.

A lead wire is connected to the aluminum collector and the terminal is drawn out to the outside by the lead wire. The characteristic and use of the cylinder-type electric double layer capacitor are similar to those of the square-type electric double layer capacitor, but in the case of a large-capacity cylinder-type electric double layer capacitor, an output characteristic is reduced due to an increase of contact resistance caused by numerous draw-out electrodes.

As the type of the electric double layer capacitor which is presently produced in mass, the cylinder-type, the coin-type, and the square-type are mainly used. However, it is very difficult to apply the surface-mount technology to this type electric double layer capacitor.

Further, since mounting of the chip-type electric double layer capacitor through the SMT requires a high-temperature reflow process, there is a problem of leakage of electrolyte solution filled within the chip-type electric double layer capacitor.

### SUMMARY OF THE INVENTION

The present invention has been invented in order to overcome the above-described problem and it is, therefore, an object of the present invention to provide a chip-type electric double layer capacitor and a package structure thereof, in which protrusions are formed on a lower package of a chip-type electric double layer capacitor to which an SMT can be applied, thereby reducing transmitted heat in a reflow process.

In accordance with one aspect of the present invention to achieve the object, there is provided a package structure of a chip-type electric double layer capacitor which includes a lower package, which houses an electric double layer element and has a package terminal formed thereon to be electrically connected to the electric double layer element, and an upper package which is disposed on a top part of the lower package and seals the electric double layer element from the outside, wherein the package terminals are formed to be protruded from an internal bottom surface and an external bottom surface of the lower package, and the external bottom surface of the lower package has at least two pairs of protrusions formed thereon.

Further, preferably, the protrusions have heights higher than those of the package terminals, respectively.

Further, preferably, the protrusions are made of at least one polymer of polyvinyl alcohol (PVA), polyvinylidene fluoride (PVDF), polypropylene (PP), a teflon resin, a silicon resin, a modified silicon, and styrene-butyl rubber (SBR).

Further, preferably, the lower package is injection-molded together with the package terminals formed on the bottom surface of the lower package.

Further, preferably, attached surfaces between the lower package and the upper package are sealed from the outside by using ultrasonic fusion or laser fusion.

Further, preferably, the protrusions are formed in a semi-sphere shape, or a polygonal-horn shape.

Further, preferably, the protrusions are integrally formed together with the lower package.

In accordance with another aspect of the present invention to achieve the object, there is provided a chip-type electric double layer capacitor including: an electric double layer element; and a package including a lower package, which houses the electric double layer element and has package terminals formed thereon to be electrically connected to the electric double layer element, and an upper package which is disposed on a top part of the lower package and seals the electric double layer element from the outside, wherein the package terminals are formed to be protruded from an internal bottom surface and an external bottom surface of the lower package, and the external bottom surface of the lower package have at least two pairs of protrusions formed thereon.

Further, preferably, the lower package is filled with electrolyte solution.

Further, preferably, the protrusions have heights higher than those of the package terminals.

Further, preferably, the protrusions are made of at least one polymer of polyvinyl alcohol (PVA), polyvinylidene fluoride (PVDF), polypropylene (PP), a teflon resin, a silicon resin, a modified silicon, and styrene-butyl rubber (SBR).

Further, preferably, the lower package is injection-molded together with the package terminals formed on the bottom surface of the lower package.

Further, preferably, attached surfaces between the lower package and the upper package are sealed from the outside by using ultrasonic fusion or laser fusion.

Further, preferably, the protrusions and the lower package are integrally formed.

Further, preferably, the protrusions are formed in a semi-sphere shape, or a polygonal-horn shape.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a bottom cross-sectional view showing a package structure of a chip-type electric double layer capacitor in accordance with an embodiment of the present invention;

FIG. 2 is a side cross-sectional view showing a package structure of a chip-type electric double layer capacitor in accordance with an embodiment of the present invention;

FIG. 3 is a perspective view showing a chip-type electric double layer capacitor in accordance with another embodiment of the present invention; and

FIG. 4 is a view showing a profile of a reflow process in accordance with an embodiment of the present invention.

### DETAILED DESCRIPTION OF THE PREFERABLE EMBODIMENTS

A matter regarding to a configuration and an effect of the present invention will be appreciated clearly through the following detailed description with reference to the accompanying drawings illustrating preferable embodiments of the present invention. Hereinafter, an embodiment in accordance with the present invention will be described in detail with reference to the accompanying drawings.

Hereinafter, a chip-type electric double layer capacitor (EDLC) and a package structure thereof will be described in detail with reference to the accompanying drawings. Like elements refer to like reference numerals and a repeated description thereof will be omitted.

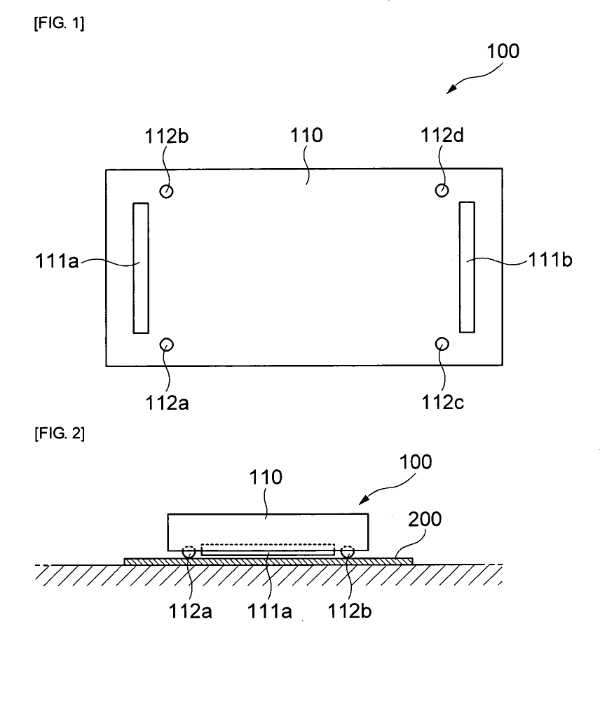

FIG. 1 is a bottom cross-sectional view showing a package structure of a chip-type electric double layer capacitor in accordance with an embodiment of the present invention, and FIG. 2 is a side cross-sectional view showing a package structure of the chip-type electric double layer capacitor in accordance with an embodiment of the present invention.

As shown in FIGS. 1 and 2, a package structure of the chip-type electric double layer capacitor in accordance with the embodiment of the present invention includes a lower package 110 and an upper package (not shown).

The lower package 110 houses an electric double layer element 120 and is provided with package terminals 111a and 111b formed on the bottom surface thereof, wherein the package terminals 111a and 111b are electrically connected to the electric double layer element 120. The upper package (not shown), which covers a top surface of the lower package, is disposed on the top part of the lower package 110 and performs a function of sealing the electric double layer element from the outside.

The package terminals 111a and 111b formed on the lower package 110 are formed in a shape protruding from an internal bottom surface and an external bottom surface of the lower package 110. Also, the lower package 110 has at least two pairs of protrusions 112a to 112d formed on the internal and external bottom surfaces thereof.

Since the package terminals 111a and 111b formed on the lower package 110 are attached to electric terminals of the electric double layer element 120 housed within the package, they are formed of a material capable of conducting electricity.

At least two pairs of the protrusions 112a to 112d are formed on the external bottom surface of the lower package 110. The protrusions 112a to 112d may be protruded into the bottom surface of the lower package 110.

The protrusions 112a to 112d may be formed to have heights higher than those of the package terminals 111a and 111b, respectively.

When the lower package 110 has no protrusions 112a to 112d formed thereon, package terminals protruded to the outside of the chip-type electric double layer capacitor package are disposed to be attached to a substrate, and after the reflow process, heat is transmitted to the chip-type electric double layer capacitor package through the package terminals attached to the susbstrate.

In this case, since the package terminals attached to the substrate occupy a wide surface area, a large amount of heat is transmitted to the chip-type electric double layer capacitor package, which causes deformation of the package and damage of the attached portion. Therefore, the package terminals attached to the substrate results in leakage of the electrolyte solution within the package.

Meanwhile, when the lower package 110 has the protrusions 112a to 112d formed thereon, the protrusions 112a to 112d protruded on the bottom surface of the chip-type electric double layer capacitor package are attached to the substrate and a space is formed between the package terminals 111a and 111b and the substrate. Therefore, it is possible to avoid direct transmission of heat to the chip-type electric double layer capacitor package through the package terminals 111a and 111b even if the reflow process is undergone.

As a result, formation of the protrusions 112a to 112d on the lower package can provide an effect of lowering heat conductivity, in comparison with the case where heat is transmitted to the chip-type electric double layer capacitor 100 through the package terminals 111a and 111b.

The protrusions 112a to 112d formed on the bottom surface of the lower package 110 may be made of at least one polymer of polyvinyl alcohol (PVA), polyvinylidene fluoride (PVDF), polypropylene (PP), a Teflon(polytetrafluorethylene: PTFE) resin, a silicon resin, a modified silicon, and styrene-butyl rubber (SBR). The protrusions 112a to 112d may be formed in various shapes of a semi-sphere shape, a polygonal horn shape, or the like.

The protrusions 112a to 112d may be integrally injection-molded together with the lower package 110, and the number of the protrusions may become a plural (e.g. two, three, and four). A plurality of the protrusions may be positioned such that center of gravity of the protrusions coincides with center of gravity of the lower package.

In the chip-type electric double layer capacitor package structure, the lower package may be injection-molded together with the package terminals formed on the bottom surface of the lower package.

When the lower package is injection-molded together with the package terminals, there is no space generated between the lower package and the package terminals, so that it is possible to prevent the electrolyte solution from being leaked to the outside.

Also, attached surfaces between the lower and upper packages are sealed through ultrasonic fusion or laser fusion, and thus it is possible to prevent leakage of the electrolyte solution within the package in the reflow process.

As shown in FIG. 2, the protrusions 112a to 112d formed on the bottom surface of the package have heights higher than those of the package terminals 111a and 111b, respectively.

Therefore, since the protrusions 112a to 112d formed on the bottom surface of the chip-type electric double layer capacitor package are attached to the substrate, a surface area at which they are attached to the substrate may be much more reduced, in comparison with a case where the chip-type electric double layer capacitor package has no protrusions 112a to 112d formed thereon.

When heat is transmitted from a lower part of the chip-type electric double layer capacitor package during the reflow process, an air layer is generated on a central portion of the package terminals 111a and 111b while the package terminals 111a and 111b are being melted. Therefore, both ends of the package terminals 111a and 111b are attached to the substrate 200, so the chip-type electric double layer capacitor 100 is electrically connected to the substrate 200.

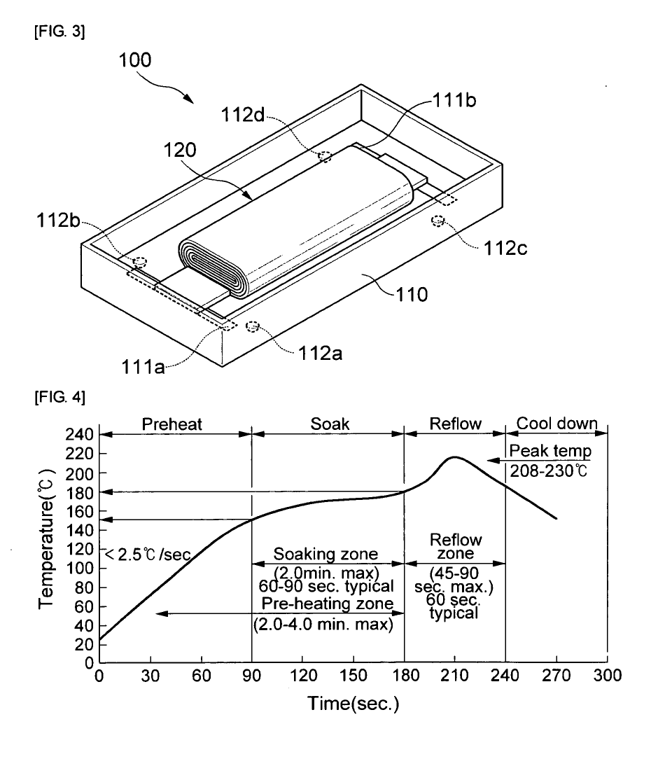

FIG. 3 is a perspective view showing a chip-type electric double layer capacitor in accordance with another embodiment of the present invention.

As shown in FIG. 3, the chip-type electric double layer capacitor 100 in accordance with another embodiment of the present invention includes an electric double layer element 120, and a package 110.

The electric double layer element includes two electrodes with different polarities, and at least one separator.

The two electrodes with two different polarities may have electrode terminals protruded on sides opposite to each other. The electrode terminals are attached to terminals of the lower package to thereby be electrically connected to the package terminals, respectively.

One electrode has an electrode terminal protruded on one side thereof, and two electrodes and electrode terminals are formed to have the same size and shape as each other. At least one separator is interposed between two electrodes so that two electrodes can be prevented from being short-circuited.

For example, a first separator is disposed and a first electrode is laminated on the first electrode, and a second separator and a second electrode are sequentially laminated on the first electrode. In this case, electrode terminals of the first electrode and electrode terminals of the second electrode are disposed to be protruded in opposite directions to each other.

The electric double layer element may be formed in a cylinder type, and a square type by laminating two electrodes and two separators and then winding the two electrodes based on a reference axis.

The package structure as described above is made by attaching the electric double layer element to the inside of the lower package, filling electrolyte solution within the lower package, and then sealing the electric double layer element from the outside through ultrasonic fusion or laser fusion after covering of the upper package.

FIG. 4 is a view showing a profile of the reflow process in accordance with an embodiment of the present invention.

In general, in the reflow process, heat with temperature of about 240° C. to 260° C. is transmitted for about 45 to 90 seconds.

Therefore, when the package terminals are directly attached to the substrate, high temperature generated in the reflow process causes deformation of the package, as well as leakage of the electrolyte solution to the attached portion.

When a package structure of a chip-type electric double layer capacitor in accordance with the embodiment of the present invention is implemented, it is possible to reduce heat transmitted to the chip-type electric double layer capacitor, which provides solution for the above-described problems even if the reflow process is undergone.

In the embodiment of the present invention, endurable design to reflow profile is made in a package structure of the chip-type electric double layer capacitor, thereby preventing leackage of solution during the reflow process.

Moreover, chip-type electric double layer capacitor is provided, so that it is possible to apply the SMT and to secure stability in applying the SMT.

As described above, although the preferable embodiments of the present invention have been shown and described, it will be appreciated by those skilled in the art that substitutions, modifications and changes may be made in these embodiments without departing from the principles and spirit of the general inventive concept, the scope of which is defined in the appended claims and their equivalents.

What is claimed is:

1. A package structure of a chip-type electric double layer capacitor which includes a lower package, which houses an electric double layer element and has a package terminal formed thereon to be electrically connected to the electric double layer element, and an upper package which is disposed on a top part of the lower package and seals the electric double layer element from the outside,
wherein the package terminals are formed to be protruded from an internal bottom surface and an external bottom surface of the lower package, and the external bottom surface of the lower package has at least two pairs of protrusions formed thereon.

2. The package structure of claim 1, wherein the protrusions have heights higher than those of the package terminals, respectively.

3. The package structure of claim 1, the protrusions are made of at least one polymer of polyvinyl alcohol (PVA), polyvinylidene fluoride (PVDF), polypropylene (PP), a Teflon resin, a silicon resin, a modified silicon, and a styrene-butyl rubber (SBR).

4. The package structure of claim 1, wherein the lower package is injection-molded together with the package terminals formed on the bottom surface of the lower package.

5. The package structure of claim 1, wherein attached surfaces between the lower package and the upper package are sealed from the outside by using ultrasonic fusion or laser fusion.

6. The package structure of claim 1, wherein the protrusions are formed in a semi-sphere shape, or a polygonal-horn shape.

7. The package structure of claim 1, wherein the protrusions are integrally formed together with the lower package.

8. A chip-type electric double layer capacitor comprising:
an electric double layer element; and
a package including a lower package, which houses the electric double layer element and has package terminals formed thereon to be electrically connected to the electric double layer element, and an upper package which is disposed on a top part of the lower package and seals the electric double layer element from the outside,
wherein the package terminals are formed to be protruded from an internal bottom surface and an external bottom surface of the lower package, and the external bottom surface of the lower package have at least two pairs of protrusions formed thereon.

9. The chip-type electric double layer capacitor of claim 8, wherein the lower package is filled with electrolyte solution.

10. The chip-type electric double layer capacitor of claim 8, wherein the protrusions have heights higher than those of the package terminals.

11. The chip-type electric double layer capacitor of claim 8, wherein the protrusions are made of at least one polymer of polyvinyl alcohol (PVA), polyvinylidene fluoride (PVDF), polypropylene (PP), a teflon resin, a silicon resin, a modified silicon, and styrene-butyl rubber (SBR).

12. The chip-type electric double layer capacitor of claim 8, wherein the lower package is injection-molded together with the package terminals formed on the bottom surface of the lower package.

13. The chip-type electric double layer capacitor of claim 8, wherein attached surfaces between the lower package and the upper package are sealed from the outside by using ultrasonic fusion or laser fusion.

14. The chip-type electric double layer capacitor of claim 8, wherein the protrusions and the lower package are integrally formed.

15. The chip-type electric double layer capacitor of claim 8, wherein the protrusions are formed in a semi-sphere shape, or a polygonal-horn shape.
